(19) United States
(12) Patent Application Publication
(10) Pub. No.: US 2004/0117287 A1
(43) Pub. Date: Jun. 17, 2004

(54) Fixed assets management system and method

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/644,400

(22) Filed: Aug. 19, 2003

(30) Foreign Application Priority Data
Dec. 13, 2002 (TW) 91136044

(51) Int. Cl. G06F 17/60

(52) U.S. Cl. 705/36

(57) ABSTRACT

A fixed assets management system for calculating depreciation expenses for fixed assets and revaluing varied fixed assets when fixed asset variations occur includes a database server (1), an application server (2), and a plurality of client computers (4) linking to the application server through a network (3). The application server includes a depreciation method selecting module (21) for selecting suitable depreciation methods for fixed assets; a depreciation period setting module (22) for setting appropriate depreciation periods for fixed assets; a depreciation expense calculating module (23) for calculating depreciation expenses according to purchase prices, depreciation methods and depreciation periods of fixed assets; and a fixed asset variation management module (24) for revaluing varied fixed assets when fixed asset variations occur.

### BACKGROUND OF THE INVENTION

1. Field of the Invention

The present invention relates to fixed assets management systems and methods, and especially to a fixed assets management system and method that can revalue fixed assets when fixed asset variations occur.

2. Background of the Invention

A fixed assets management system generally provides accurate calculation of depreciation expenses in order to value fixed assets appropriately through integrating information from internal budgets and financial statements of a company. The art of fixed assets management is disclosed in patents such as JP Patent No. 7,311,800 issued on Dec. 28, 1995 and entitled Fixed Assets Management System. This system comprises a host computer for inputting data of a plurality of items for each fixed asset from a data input part, and for storing the data in a data storage part; a handy terminal for reading bar codes imparted beforehand for each fixed asset by a read part inputting the data from a terminal input part; a radio communication part for performing modulation and communication; and a radio terminal for modulating and demodulating transmitted and received signals, and for inputting and outputting the signals to and from an input part. However, no means are provided in the system for managing fixed assets during their depreciation lifetime, nor for dealing with revaluing varied fixed assets. When fixed assets variations occur, the system cannot guarantee accuracy of depreciation data for the varied fixed assets.

Accordingly, there is need of providing a fixed assets management system and method, which is able to not only calculate depreciation rates and depreciation expenses year by year for fixed assets according to fixed asset types, purchase prices, usage dates, selected depreciation methods and set depreciation periods, but also revalue varied fixed assets through selecting anew depreciation methods and setting new depreciation periods.

### SUMMARY OF THE INVENTION

A main objective of the present invention is to provide a fixed assets management system and method, which can calculate depreciation expenses year by year for fixed assets according to selected depreciation methods and set depreciation periods.

Another objective of the present invention is to provide a fixed assets management system and method, which can revalue fixed assets when fixed asset variations occur.

To accomplish the above objectives, a fixed assets management system in accordance with a preferred embodiment of the present invention comprises an application server, a database server, and a plurality of client computers linking to the application server through a network, wherein the application server comprises: a depreciation method selecting module for selecting suitable depreciation methods for fixed assets; a depreciation period setting module for setting appropriate depreciation periods for fixed assets; a depreciation expense calculating module for calculating depreciation rates and depreciation expenses according to purchase prices, depreciation methods and depreciation periods of fixed assets; and a fixed asset variation management module for revaluing fixed assets when fixed asset variations occur.

Also, the present invention provides a preferred fixed asset management method for calculating depreciation expenses for a fixed asset. The method comprises the steps of: (a) obtaining information on the fixed asset from a fixed asset procurement platform; (b) providing a fixed asset management module to determine a fixed asset type, a purchase price and a usage date for the fixed asset; (c) obtaining a depreciation status statement from a database server; (d) searching in the depreciation method selecting module to determine whether a depreciation method for the fixed asset has been selected; (e) searching in the depreciation period setting module to determine whether a depreciation period for the fixed asset has been set; and (f) providing a depreciation expense calculating module to calculate a depreciation rate and a depreciation expense of each year for the fixed asset in accordance with the purchase price, the depreciation method and the depreciation period.

Further, the present invention provides a preferred fixed assets management method for revaluing a varied fixed asset when a fixed asset variation occurs. The method comprises the steps of: (a) receiving information on the varied fixed asset; (b) accessing a relevant depreciation status statement for the varied fixed asset from a database sever; (c) providing a fixed asset variation management module to calculate a residual value for the varied fixed asset according to a purchase price and depreciation expenses in the depreciation status statement; (d) designating a new usage date; (e) providing a depreciation method selecting module to select anew a depreciation method for the varied fixed asset; (f) providing a depreciation period setting module to set a new depreciation period for the varied fixed asset; and (g) providing a depreciation expense calculating module to calculate a depreciation rate and depreciation expense of each year for the varied fixed asset according to the residual value, the newly set depreciation method and the new depreciation period.

Other objects, advantages and novel features of the present invention will be drawn from the following detailed description of the preferred embodiment and preferred methods of the present invention with the attached drawings, in which:

### BRIEF DESCRIPTION OF THE DRAWINGS

FIG. 1 is a schematic diagram of hardware configuration of a fixed assets management system in accordance with the preferred embodiment of the present invention;

FIG. 2 is a schematic diagram showing main function units of an application server of the system of FIG. 1;

FIG. 3 is a table showing main items on an exemplary depreciation status statement for fixed assets, in accordance with the present invention;

FIG. 4 is a flowchart illustrating a preferred method of calculating depreciation expenses for a fixed asset; and

FIG. 5 is a flowchart illustrating a preferred method of calculating depreciation expenses for a varied fixed asset.

### DETAILED DESCRIPTION OF THE INVENTION

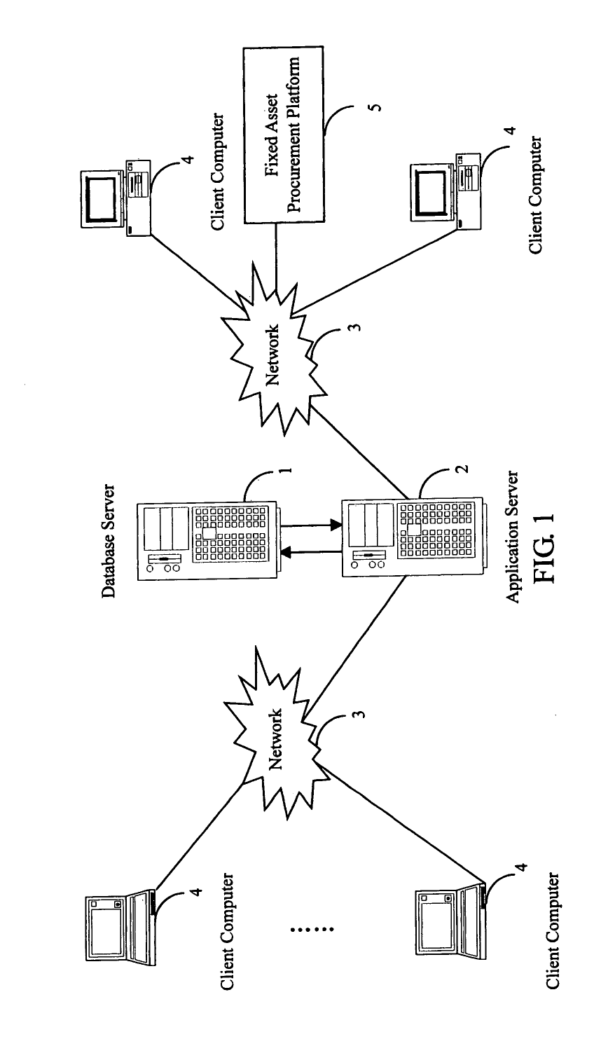

FIG. 1 is a schematic diagram of hardware configuration of a fixed assets management system in accordance with the preferred embodiment of the present invention. The fixed assets management system comprises a database server 1, an application server 2 linking to the database server 1, a plurality of client computers 4, and a fixed asset procurement platform 5 connected to the application server 2 through a network 3. The database server 1 comprises a database for storing data and depreciation status statements regarding fixed assets. The application server 2 is for selecting suitable depreciation methods and setting appropriate depreciation periods for various fixed assets according to types of the fixed assets and usage dates of the fixed assets, and for calculating depreciation expenses for the fixed assets. The depreciation methods comprise a depreciation double-declining balance method, a depreciation-straight line method, a depreciation-fifty-percent method, and so on. Furthermore, when fixed asset variations occur, such as transferring of a fixed asset between internal departments, scrapping a fixed asset or repairing a fixed asset, the application server 2 can revalue the fixed asset if necessary. The client computers 4, which are located at different places in an organization, are used for searching depreciation status information and fixed asset variations. The fixed asset procurement platform 5 provides an operating platform for fixed asset purchases, and offers original data comprising fixed asset types, purchase prices and usage dates for purchased fixed assets.

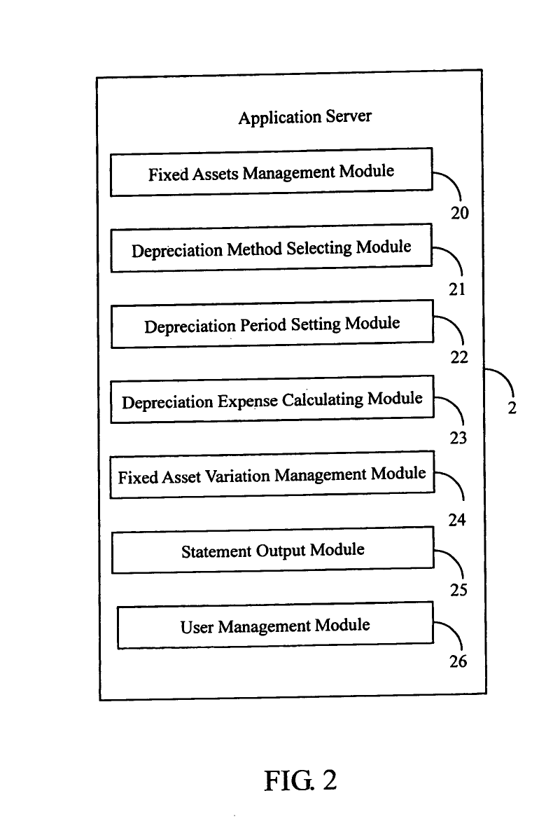

FIG. 2 is a schematic diagram of main function units of the application server 2. The application server 2 comprises a fixed assets management module 20, a depreciation method selecting module 21, a depreciation period setting module 22, a depreciation expense calculating module 23, a fixed asset variation management module 24, a statement output module 25, and a user management module 26. The fixed assets management module 20 obtains fixed asset information from the fixed asset procurement platform 5, and determines fixed asset types, purchase prices and usage dates for various fixed assets. The depreciation method selecting module 21 selects suitable depreciation methods for fixed assets according to the types of the fixed assets. The depreciation period setting module 22 sets appropriate depreciation periods for the fixed assets in accordance with the types of the fixed assets. The depreciation expense calculating module 23 is for calculating depreciation rates and expenses of each year for fixed assets according to the purchase prices, the depreciation methods and the depreciation periods of the fixed assets. The fixed asset variation management module 24 is for revaluing fixed assets when fixed asset variations occur. The statement output module 25 generates depreciation status statements for fixed assets. The user management module 26 manages user information of all fixed assets.

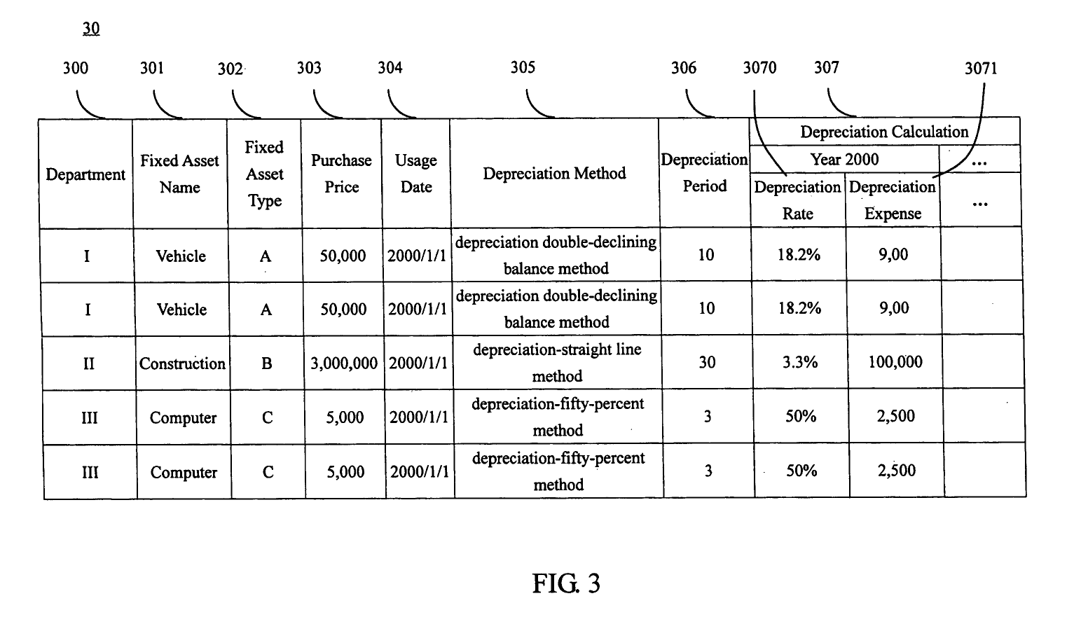

FIG. 3 is a table showing main items on an exemplary depreciation status statement 30 for fixed assets, in accordance with the present invention. The depreciation status statement 30 comprises columns for entry of a department 300, a fixed asset name 301, a fixed asset type 302, a purchase price 303, a usage date 304, a depreciation method 305, a depreciation period 306, and a depreciation calculation 307. The depreciation calculation 307 further comprises a depreciation rate 3070 and a depreciation expense 3071 for each of applicable years. The department 300 records information on a department of the organization that possesses a fixed asset. The fixed asset name 301 records a name of the fixed asset. The fixed asset type 302 records a type of the fixed asset. The fixed asset type 302 can be used as a reference when selecting the depreciation method 305 and the depreciation period 306. The purchase price 303, which can be accessed from the fixed asset procurement platform 5, records a purchase price of the fixed asset. The usage date 304 records a date when the fixed asset is first put into use. The depreciation method 305 records a suitable depreciation method selected for the fixed asset according to the fixed asset type 302. The depreciation period 306 records an appropriate depreciation period set for the fixed asset according to the fixed asset type 302. The depreciation rate 3070 and the depreciation expense 3071 respectively record a depreciation rate and a depreciation expense of each calendar year when the fixed asset is being utilized. The depreciation rate 3070 and the depreciation expense 3071 can be calculated according to the depreciation method 305 and the depreciation period 306.

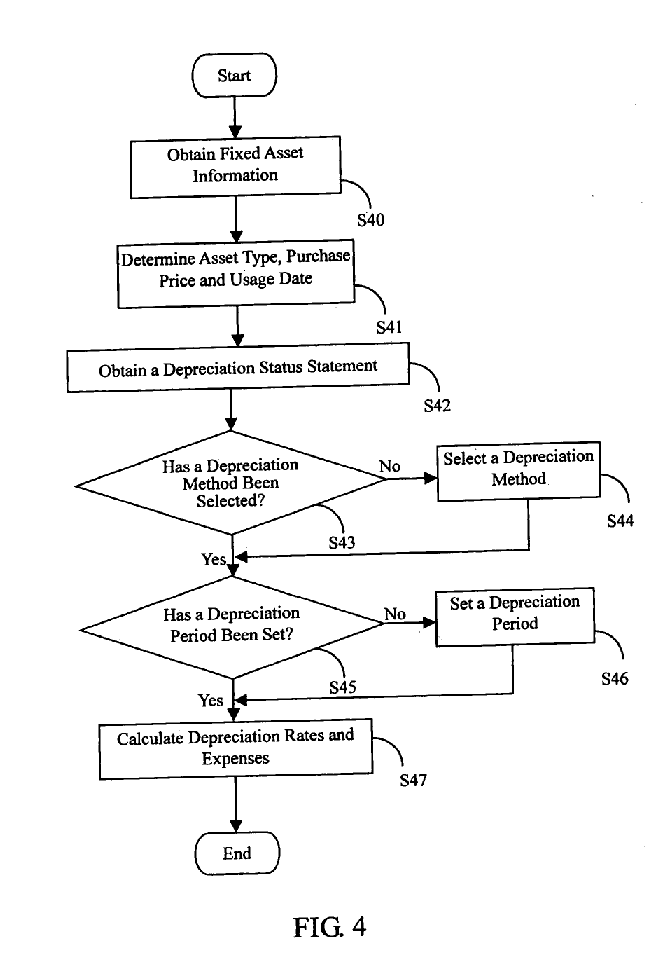

FIG. 4 is a flowchart illustrating a preferred method of calculating depreciation expenses for a fixed asset. In step S40, the application server 2 obtains information on the fixed asset from the fixed asset procurement platform 5. In step S41, the fixed assets management module 20 determines the fixed asset type 302, the purchase price 303 and the usage date 304 for the fixed asset. In step S42, the application server 2 obtains a depreciation status statement 30 from the database server 1. In step S43, the application server 2 searches in the depreciation method selecting module 21 to determine whether a depreciation method 305 for the fixed asset has been selected. If no depreciation method 305 has been selected, in step S44, the depreciation method selecting module 21 selects a suitable depreciation method 305 for the fixed asset according to the fixed asset type 302. If and when a depreciation method 305 has been selected, in step S45, the application server 2 searches in the depreciation period setting module 22 to determine whether a depreciation period 306 for the fixed asset has been set. If no depreciation period 306 has been set, in step S46, the depreciation period setting module 22 sets an appropriate depreciation period 306 for the fixed asset according to the fixed asset type 302. In step S47, the depreciation expense calculating module 23 calculates the depreciation rate 3070 and the depreciation expense 3071 of each year for the fixed asset in accordance with the purchase price 303, the depreciation method 305 and the depreciation period 306.

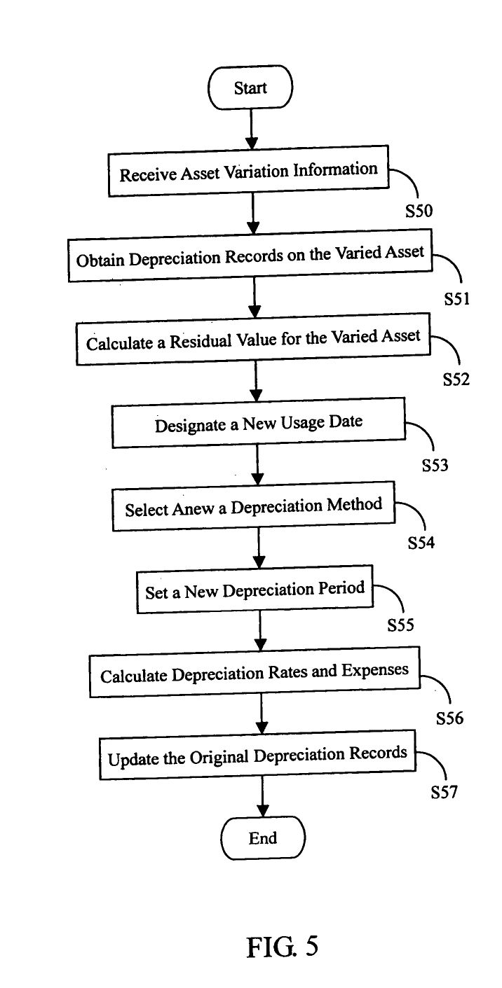

FIG. 5 is a flowchart illustrating a preferred method of calculating depreciation expenses for a varied fixed asset. In step S50, the application server 2 receives information on a fixed asset variation. In step S51, the application server 2 accesses a relevant depreciation status statement 30 for the varied fixed asset from the database server 1. The depreciation status statement 30 shows information on depreciation records for the varied fixed asset. In step S52, the fixed asset variation management module 24 calculates a residual value for the varied fixed asset according to the purchase price 303 and the depreciation expenses 3071 in the depreciation status statement 30. In step S53, the asset variation management module 24 designates the varied date as a new usage date 304. In step S54, the depreciation method selecting module 21 selects anew a depreciation method for the varied fixed asset according to the asset type 302. In step S55, the depreciation period setting module 22 sets a new depreciation period 306 for the varied fixed asset according to the fixed asset type 302. In step S56, the depreciation expense calculating module 24 calculates the depreciation rate 3070 and the depreciation expense 3071 of each year for the varied fixed asset according to the residual value, the newly set depreciation method 305 and the new depreciation period 306. In step S57, the fixed asset variation management module 24 updates the original depreciation records in the depreciation status statement 30 of the varied fixed asset to generate a new depreciation status statement 30.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. A fixed assets management system for calculating depreciation expenses and revaluing fixed assets when fixed asset variations occur, the fixed assets management system comprising an application server, a database server, and a plurality of client computers linking to the application server through a network, wherein the application server comprises:
a depreciation method selecting module for selecting suitable depreciation methods for fixed assets;
a depreciation period setting module for setting appropriate depreciation periods for fixed assets;
a depreciation expense calculating module for calculating depreciation expenses according to purchase prices, depreciation methods and depreciation periods of fixed assets; and
a fixed asset variation management module for revaluing fixed assets when fixed asset variations occur.

2. The fixed assets management system according to claim 1, further comprising a fixed asset procurement platform for purchasing fixed assets and providing original data such as fixed asset types, purchase prices, and usage dates for purchased fixed assets.

3. The fixed assets management system according to claim 1, wherein the application server further comprises a fixed assets management module for obtaining fixed asset information from the fixed asset procurement platform, and determining fixed asset types, purchase prices and usage dates for fixed assets.

4. The fixed assets management system according to claim 1, wherein the application server further comprises a statement output module for generating depreciation status statements for fixed assets.

5. The fixed assets management system according to claim 1, wherein the application server further comprises a user management module for managing user information of all fixed assets.

6. A fixed assets management method for calculating depreciation expenses for a fixed asset, the method comprising the steps of:
(a) obtaining information on the fixed asset from a fixed asset procurement platform;
(b) providing a fixed assets management module to determine a fixed asset type, a purchase price and a usage date for the fixed asset;
(c) obtaining a depreciation status statement from a database server;
(d) searching in the depreciation method selecting module to determine whether a depreciation method for the fixed asset has been selected;
(e) searching in the depreciation period setting module to determine whether a depreciation period for the fixed asset has been set; and
(f) providing a depreciation expense calculating module to calculate a depreciation rate and a depreciation expense of each year for the fixed asset in accordance with the purchase price, the depreciation method and the depreciation period.

7. The fixed assets management method according to claim 6, wherein step (d) further comprises the step of selecting a suitable depreciation method for the fixed asset if no depreciation method has been selected for the fixed asset.

8. The fixed assets management method according to claim 6, wherein step (e) further comprises the step of the setting an appropriate depreciation period for the fixed asset if no depreciation period has been set for the fixed asset.

9. A fixed assets management method for revaluing a varied fixed asset when a fixed asset variation occurs, the method comprising the steps of:
receiving information on the varied fixed asset;
accessing a relevant depreciation status statement for the varied fixed asset from the database sever;
providing a fixed asset variation management module to calculate a residual value for the varied fixed asset according to a purchase price and depreciation expenses in the depreciation status statement;
designating a new usage date;
providing a depreciation method selecting module to select a new a depreciation method for the varied fixed asset;
providing a depreciation period setting module to set a new depreciation period for the varied fixed asset; and
providing a depreciation expense calculating module to calculate a depreciation rate and a depreciation expense of each year for the varied fixed asset according to the residual value, the newly set depreciation method and the new depreciation period.

10. The fixed assets management method according to claim 9, further comprising the step of updating original depreciation records in the depreciation status statement of the varied fixed asset to generate a new depreciation status statement.
